(19) United States
(12) Patent Application Publication
(10) Pub. No.: US 2018/0106297 A1
(43) Pub. Date: Apr. 19, 2018

(54) Coupling Apparatus

(71) Applicant: Apex Dynamics, Inc., Taichung City (TW)

(72) Inventor: Robin C.S. Chang, Taichung City (TW)

(21) Appl. No.: 15/294,828

(22) Filed: Oct. 17, 2016

(51) Int. Cl. F16D 3/68

(52) U.S. Cl. CPC F16D 3/68

(57) ABSTRACT

A coupling apparatus includes a bellows, two rings and two axle-connecting elements. The bellows includes two ends and two rolled edges each formed at a corresponding one of the ends. Each of the rings is connected to a corresponding one of the ends of bellows. Each of the axle-connecting elements is connected to a corresponding one of the rings.

### BACKGROUND OF INVENTION

### 1. Field of Invention

The present invention relates to axles and, more particularly, to a coupling apparatus for interconnecting two axles.

### 2. Related Prior Art

In mechanical transmission, a coupling apparatus is often used to interconnect two axles. There are various coupling apparatuses to satisfy various needs. A bellows-based coupling apparatus is often used in servo-transmission, digitally controlled transmission or synchronous transmission since it possesses a small moment of inertia, stands high temperature, is useful for high-speed rotation, compensates bias between two axles that are not perfectly coaxial, buffers axial gaps, resists vibration and synchronously transmits.

Referring to FIGS. 5 and 6, a conventional bellows-based coupling apparatus includes a bellows 91, two rings 92 and two axle-connecting elements 93. The bellows 91 are connected, at two ends, to the rings 92 and each of the axle-connecting elements 93 is partially inserted in a corresponding one of the rings 92 so that they are co-axial. Each of the rings 92 includes, at each end, a groove 922 for receiving a corresponding edge 912 of the bellows 91. Several problems have been encountered in using this conventional bellows-based coupling apparatus. At first, the rigidity of the bellows 91 is insufficient because it is made of a thin sheet and includes two open ends. Second, the edges 912 of the bellows 91 do not perfectly extend along circles because of insufficient rigidity. Thirdly, it is difficult to insert the edges 912 of the bellows 91 in the grooves 922 because the edges 912 of the bellows 91 do not perfectly extend along circles.

Referring to FIG. 7, in another conventional bellows-based coupling apparatus, each ring 92 does not include any grooves for receiving the edges 912 of the bellows 91. Each edge 912 of the bellows 91 is kept around a portion of the corresponding ring 92 by a ferrule 94. However, the width of the ferrule 94 must be large to keep each edge 912 of the bellows 91 flat on the corresponding ring 92, and it is difficult to place a wide ferrule onto each edge 912.

Referring to FIG. 8, in another conventional bellows-based coupling apparatus, each edge 912 of the bellows 91 is kept around a portion of the corresponding ring 92 by a band 95. However, the edges 912 of the bellows 91 tend to flip. Thus, the edges 912 are aesthetically unpleasant. In addition, the edges 912 are dangerous because they are thin and sharp and could easily cut a user.

The present invention is therefore intended to obviate or at least alleviate the problems encountered in prior art.

### SUMMARY OF INVENTION

It is the primary objective of the present invention to provide a.

To achieve the foregoing objective, the coupling apparatus includes a bellows, two rings and two axle-connecting elements. The bellows includes two ends and two rolled edges each formed at a corresponding one of the ends. Each of the rings is connected to a corresponding one of the ends of bellows. Each of the axle-connecting elements is connected to a corresponding one of the rings.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a coupling apparatus according to the preferred embodiment of the present invention;

FIG. 2 is an exploded view of the coupling apparatus shown in FIG. 1;

FIG. 3 is an enlarged cross-sectional view of the coupling apparatus shown in FIG. 1;

FIG. 4 is an enlarged partial view of the coupling apparatus shown in FIG. 3;

FIG. 5 is a cross-sectional view of a conventional coupling apparatus;

FIG. 6 is an enlarged partial view of the conventional coupling apparatus shown in FIG. 5;

FIG. 7 is a cross-sectional view of another conventional coupling apparatus; and

FIG. 8 is a cross-sectional view of another conventional coupling apparatus.

### DETAILED DESCRIPTION OF PREFERRED EMBODIMENT

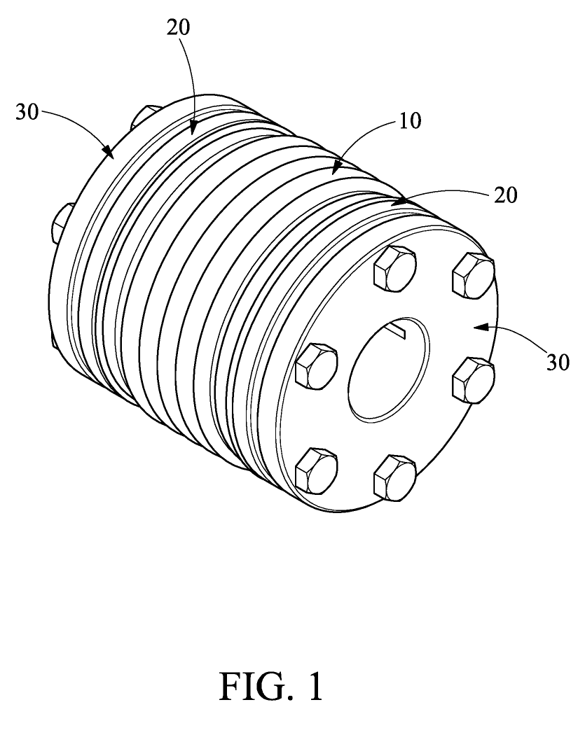

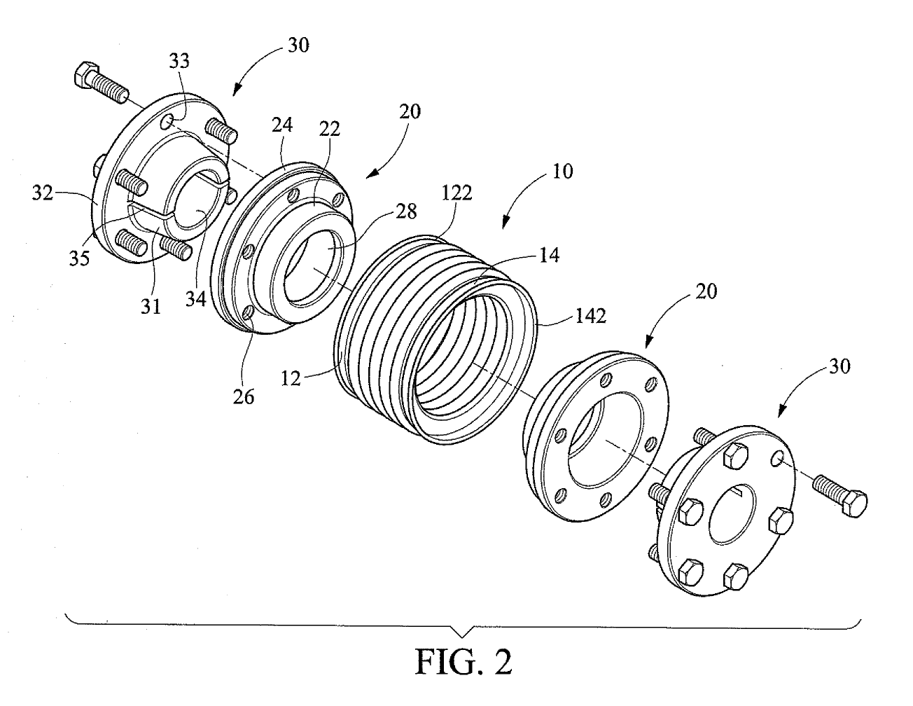

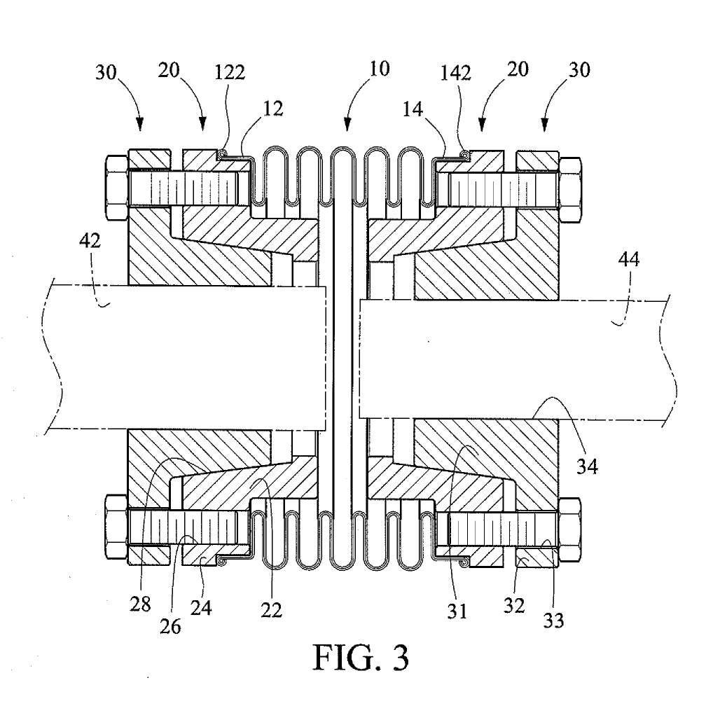

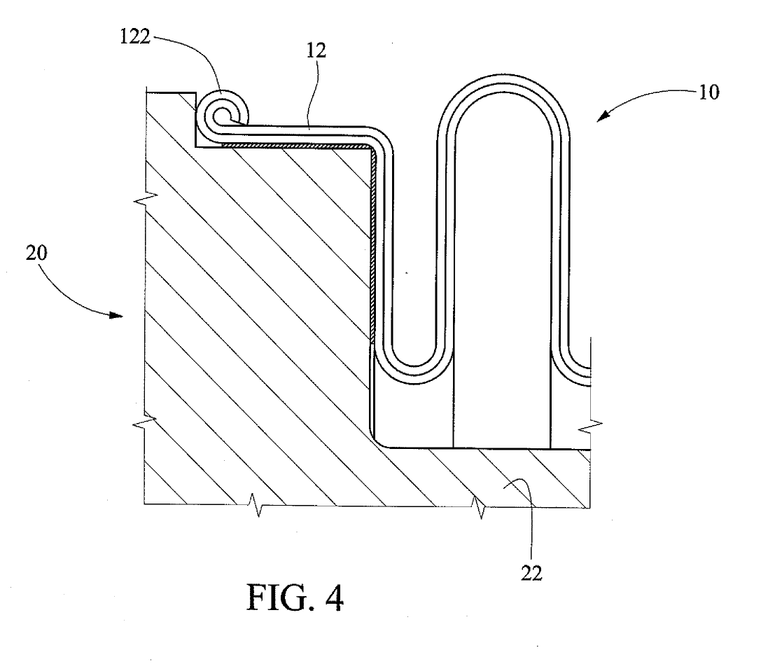

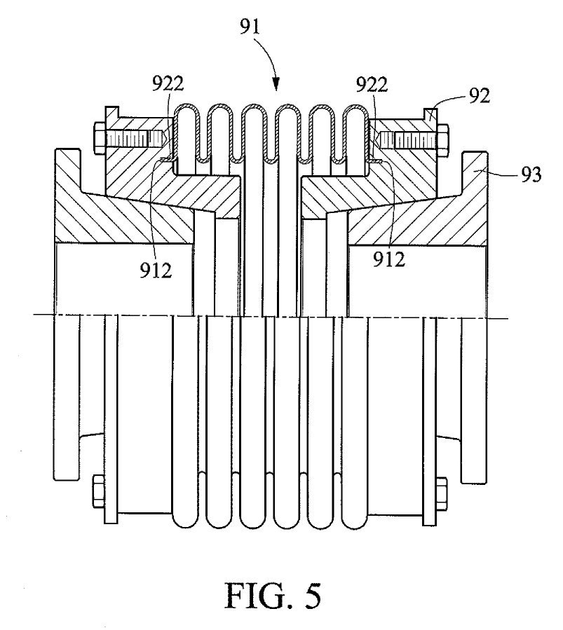

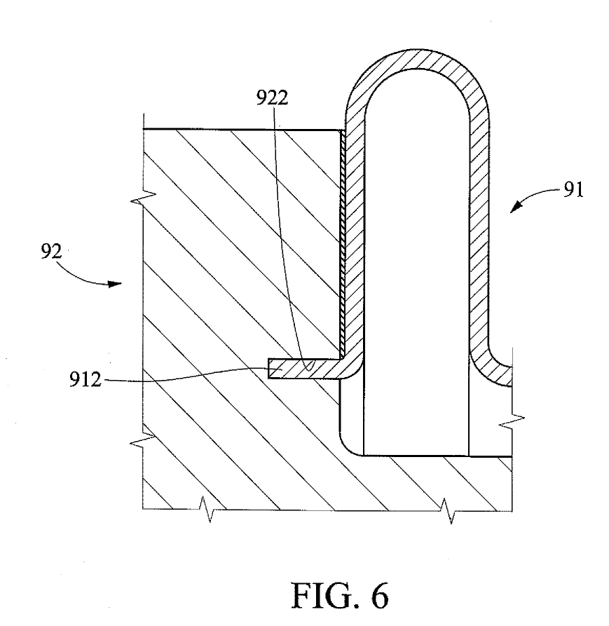

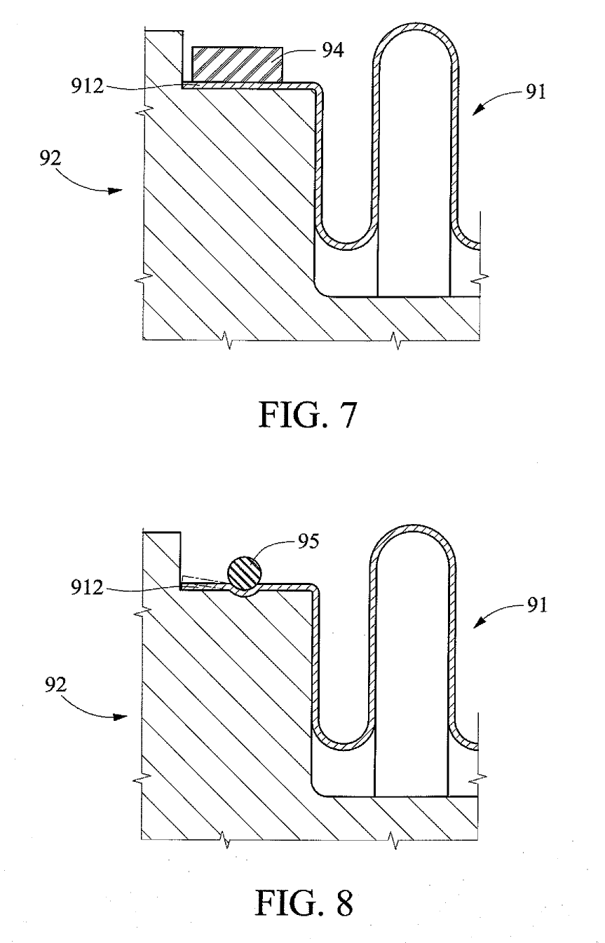

Referring to FIGS. 1 through 4, a coupling apparatus includes a bellows 10, two rings 20 and two axle-connecting elements 30 according to the preferred embodiment of the present invention. The bellows 10, the rings 20 and the axle-connecting elements 30 are intended to be coaxial. The bellows 10 is located between the rings 20, and the rings 20 are located between the axle-connecting elements 30.

The bellows 10 is a tubular element made of a thin sheet or a laminate of thin sheets, and includes folds. The bellows 10 includes two ends 12 and 14, a rolled edge 122 at the end 12, and another rolled edge 142 at the end 14.

Each of the rings 20 includes an insert 22 at an end, a flange 24 at another end, several screw holes 26 at least in the flange 24, and a central bore 28. The flange 24 extends on and along the periphery of each ring 20. The screw holes 26 are located around the central bore 28. The central bore 28 is in the form of a conical frustum.

Each of the axle-connecting elements 30 includes an insert 31 at an end, a flange 32 at another end, several apertures 33 in the flange 32, a central bore 34, and several slits 35. The insert 31 is in the form of a conical frustum. The flange 32 extends on and around the periphery of each axle-connecting element 30. The apertures 33 are located corresponding to the screw holes 26. Each of the slits 35 extends throughout the insert 31 in a radial sense, and is in communication with the central bore 34. The slits 35 provide the insert 31 with proper flexibility.

In assembly, the insert 22 of each of the rings 20 is inserted in a corresponding one of the ends 12 and 14 of the bellows 10. In a conventional manner, adhesive such as anaerobic adhesive is provided between the bellows 10 and each of the rings 20.

In use, an end of an axle 42 is inserted in the central bore 34 of one of the axle-connecting elements 30 while an end of another axle 44 is inserted in the central bore 34 of the other axle-connecting element 30. The insert 31 of each of the axle-connecting elements 30 is inserted in the central bore 28 of a corresponding one of the rings 20. Threaded bolts (not numbered) are inserted in the screw holes 26 of each ring 20 via the apertures 33 of the corresponding axle-connecting element 30, securing the rings 20 to the axle-connecting elements 30. The use of the threaded bolts moves the axle-connecting elements 30 toward the rings 20 and causes the walls of the central bores 28 of the rings 20 to press and hence deform the inserts 31 of the axle-connecting elements 30. Thus, the inserts 31 of the axle-connecting elements 30 clamp the axles 42 and 44. Hence, torque can be transmitted between the axles 42 and 44 via the coupling apparatus.

The coupling apparatus according to the present invention exhibits several advantages over the conventional bellows-based coupling apparatuses. Firstly, in the case that the bellows 10 is made of a laminate of thin sheets, slipping of the thin sheets on one another is avoided due to the use of the rolled edges 122 and 124 of the bellows 10.

Secondly, the rolled edges 122 and 124 perfectly extend along circles because the rolled configuration provides enlarged dimensions and increased strength.

Thirdly, the inserts 21 of the rings 20 can easily be inserted in the ends 12 and 14 of the bellows 10 because the rolled edges 122 and 124 perfectly extend along circles.

Fourthly, the ends 12 and 14 of the bellows 10 do not flip due to the use of the rolled edges 122 and 124.

Fifthly, the bellows 10 is aesthetically pleasant and operatively safe the ends 12 and 14 of the bellows 10 do not flip.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A coupling apparatus comprising:
a bellows (10) comprising two ends (12, 14) and two rolled edges (122, 142) each formed at a corresponding one of the ends (12, 14);
two rings (20) each connected to a corresponding one of the ends (12, 14) of the bellows (10); and
two axle-connecting elements (30) each connected to a corresponding one of the rings (20).

2. The coupling apparatus according to claim 1 wherein each of the rings (20) comprises an insert (21) inserted in a corresponding one of the ends (12, 14) of the bellows (10), a flange (24), screw holes (26), and a central bore (28).

3. The coupling apparatus according to claim 2, wherein the central bore (28) is in the form of a conical frustum.

4. The coupling apparatus according to claim 3, wherein each of the axle-connecting elements (30) comprises an insert (31) inserted in central bore (28) of a corresponding one of the rings (20), a flange (32), apertures (33) in the flange (32) thereof corresponding to the screw holes (26) of the corresponding ring (20), and a central bore (34) for receiving an end of an axle (42, 44).

5. The coupling apparatus according to claim 4, wherein the insert (31) of each of the axle-connecting elements (30) comprises at least one slit (35) to increase flexibility thereof.

6. The coupling apparatus according to claim 5, wherein the insert (31) of each of the axle-connecting elements (30) is in the form of a conical frustum.

7. The coupling apparatus according to claim 1, wherein the bellows (10) is made of a laminate of thin sheets.

8. The coupling apparatus according to claim 7 wherein each of the rings (20) comprises an insert (21) inserted in a corresponding one of the ends (12, 14) of the bellows (10), a flange (24), screw holes (26), and a central bore (28).

9. The coupling apparatus according to claim 8, wherein the central bore (28) is in the form of a conical frustum.

10. The coupling apparatus according to claim 9, wherein each of the axle-connecting elements (30) comprises an insert (31) inserted in central bore (28) of a corresponding one of the rings (20), a flange (32), apertures (33) in the flange (32) thereof corresponding to the screw holes (26) of the corresponding ring (20), and a central bore (34) for receiving an end of an axle (42, 44).

11. The coupling apparatus according to claim 10, wherein the insert (31) of each of the axle-connecting elements (30) comprises at least one slit (35) to increase flexibility thereof.

12. The coupling apparatus according to claim 11, wherein the insert (31) of each of the axle-connecting elements (30) is in the form of a conical frustum.
